(19) United States
(12) Patent Application Publication
(10) Pub. No.: US 2014/0068677 A1
(43) Pub. Date: Mar. 6, 2014

(54) SYSTEM AND METHOD FOR GENERATING CONTENT CHANNELS

(71) Applicant: STEVIE TV LTD., Tel Aviv (IL)

(72) Inventors: Gil RIMON, Sitrya (IL); Yael Givon, Sitrya (IL)

(73) Assignee: STEVIE TV LTD., Tel Aviv (IL)

(21) Appl. No.: 14/010,723

(22) Filed: Aug. 27, 2013

Related U.S. Application Data
(60) Provisional application No. 61/694,778, filed on Aug. 30, 2012.

(51) Int. Cl. H04N 21/458

(52) U.S. Cl. CPC H04N 21/458
USPC 725/46

(57) ABSTRACT

A system and method for generating and providing content channels are provided. A system and method may obtain a plurality of content items from a plurality of sources, generate a program, include the content items in the program and provide the program to a user computing device. A system and method may include plurality of programs in a channel and provide the channel to a user. Providing a channel may include continuous content delivery.

### CROSS-REFERENCE TO RELATED APPLICATIONS

This application claims priority from U.S. Patent Application No. 61/694,778, filed Aug. 30, 2012, which is incorporated herein by reference in its entirety.

### BACKGROUND OF THE INVENTION

Modern computers and networks enable users to access or receive content from various sources. For example, the Internet enables users to view, share or download multimedia content. However, in order to receive or view content, a user needs to act, e.g., navigate to a web site, press on a link, select content, retrieve webpages etc.

Accordingly, there is a need in the art for a system and method for generating content channels that provide continuous content flow to a user based on a plurality of content sources.

### SUMMARY OF EMBODIMENTS OF THE INVENTION

A system and method for generating and providing content channels are provided. A method may include obtaining a plurality of content items from a plurality of sources; generating a program and including at least some of the content items in the program; and providing the program to a user computing device. Embodiments of the invention may include selecting content items to be included in a program based on at least one of: input from the user, a profile of the user and a preference of the user. A method may include collecting a plurality of content items from a plurality of sources; associating at least some of the content items with a program; and providing the program to a user computing device.

Embodiments of the invention may include generating a program based on at least one of: input from the user, a profile of the user and a preference of the user. In an embodiment at least one of the sources used for generating a program is a social network. In an embodiment, plurality of content items included in a program or channel includes at least two content items of two content types respectively, the two content types selected from the group consisting of: text, multimedia and image. Embodiments of the invention may include including a plurality of programs in a channel; receiving, from a user, a selection of the channel; and providing the channel to the user.

Embodiments of the invention may include presenting a list of a plurality of programs; and based on a selection of the user, providing a selected program to the user. Embodiments of the invention may include sequentially providing the plurality of programs to provide an uninterrupted and continuous content delivery channel. Embodiments of the invention may include including at least some of the content items in a stack of content items and extracting, by the computing device, content items from the stack.

In an embodiment, at least some of the plurality of sources are selected by a user. Embodiments of the invention may include enabling the user to share a channel. Embodiments of the invention may include controlling a presentation of a program on a first computing device based on input received on a second computing device. Embodiments of the invention may include causing the first computing device to present metadata related to a program based on input received on a second computing device.

In an embodiment, a program includes text and video content obtained from a social network and wherein the text and video content is presented simultaneously on the user computing device. Embodiments of the invention may include receiving, from the user, a selection of a content item included in a provided program and sharing the selected content item with members of a social network. A system may include a user computing device and a server, the server configured to: obtain a plurality of content items from a plurality of sources; generate a program and include at least some of the content items in the program; and provide the program to the user computing device.

In an embodiment, a server may be configured to select content items to be included in a program based on at least one of: input from the user, a profile of the user and a preference of the user. In an embodiment, a server may be configured to include a plurality of programs in a channel; receive, from the user, a selection of the channel; and provide the channel to the user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high level block diagram of a system according to embodiments of the present invention;

FIG. 2 shows a high level flowchart diagram and system components illustrating a system and method for generating content channels according to embodiments of the present invention;

FIG. 3 shows a high level block diagram of a system and flows according to embodiments of the present invention;

FIG. 4 shows a high level block diagram of a system and flows according to embodiments of the present invention;

FIG. 5 shows a high level block diagram of a flow according to embodiments of the present invention;

FIG. 6 shows high level block diagram of an exemplary flow device according to embodiments of the present invention; and

FIG. 7 shows a high level block diagram of an exemplary computing device according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

As described herein, a system and method according to embodiments of the invention may provide content, over a computer network, in a way or fashion that resembles a television channel. In an embodiment, content from the Internet, social networks or any applicable source may be provided as a channel of continuously streamed data to a user computer or mobile device. For example, “tweets”, “likes”, “shares”, content uploaded to the Facebook service, social networks activities or events, posts and images may be packed into a program (e.g., a set of content items or objects provided to a user) and continuously provided, as a flow or stream of data to a user's computing device.

The term “program” is referred to herein relates to one or more content items or objects intended to be provided to one or more users. A program as referred to herein may be similar to a television program or show as known in the art. For example, a news program may include one or more video clips related to recent events and a sports program may include one or more content items related to sports. Accordingly, in an embodiment, generating a program includes selecting a set of content items and associating the set of content items with a program. In an embodiment, generating a program includes obtaining a set of items (e.g., obtaining video clips, images and text strings from a plurality of web sources), storing the set of content items in association with a program identification and providing the set of content items. Accordingly, a program may be a set of content items which are associated, or grouped together. In an embodiment, generating a program includes associating one or more content items with a program. For example, server 130 may define a program, e.g., a news program by selecting a name for the program or an identification for the program and may then associate one or more content items with the program. For example, server 130 selects or receives “info moments” as a name of a program and then selects content items to be included in, or associated with the “info moments” program. A program may have a name or title and may additionally or alternatively have other identification parameters. For example, a program may be identified by, or associated with an identification number or value and the identification parameter may be used by components of a system in order to identify or refer to the program.

A program may be provided to a user by downloading the program from a server to a user's computing device. For example, a server generates a program by storing one or more content items and provides the program to a user by sending the content items to the user's computer. Users can watch a program. For example, a user watches a program provided by a system on his or her computer. For example, video clips and text included in a program are displayed on a display of a user's computer and sound associated with video clips in a program is provided via speakers attached to a user's computer.

A number of channels may be generated for a user or an audience. For example, a news channel, a comedy channel and a social channel may be generated for a specific user or for a set of similar users or for all users. Content for a channel may be obtained by a server, packed into a program or stack and delivered to a user. The term “channel” as used herein relates to one or more programs or shows as described herein. For example, a sports channel may include a set of sports programs or shows as described herein. Generally, a channel as referred to herein may be similar to a television channel as known in the art, that is, a channel may be a set of programs. For example, a user selects a channel and a system according to embodiments of the invention provides the selected channel by providing a plurality of programs which are included in the channel. For example and as further described herein, server 130 generates programs and channels and a user watches the programs or channels using computing device 700, e.g., on output device 740.

A channel may be dynamically, and in real-time, modified based on user input or based on events, either related to the user or related to a field or subject. For example, user's “likes” posted on the Internet as known in the art may be used in order to dynamically and/or in real-time select content for a channel. In other examples, events occurring near the user's location may be used. Other rules, criteria or parameters may be used in order to obtain, process or filter content in a program, channel or stack. For example, a channel may be generated or modified, possibly in real-time based on a product appearing on the market or “liked” by friends in a social network, based on viewers ratings or based on a popularity of an item.

Providing content to a user may be based on user input (e.g., pause, skip). For example, providing of a first channel may be stopped in order to commence providing a second channel based on an event (e.g., an entertainment channel may be stopped and a social channel may be provided instead based on an activity of a friend in a social network).

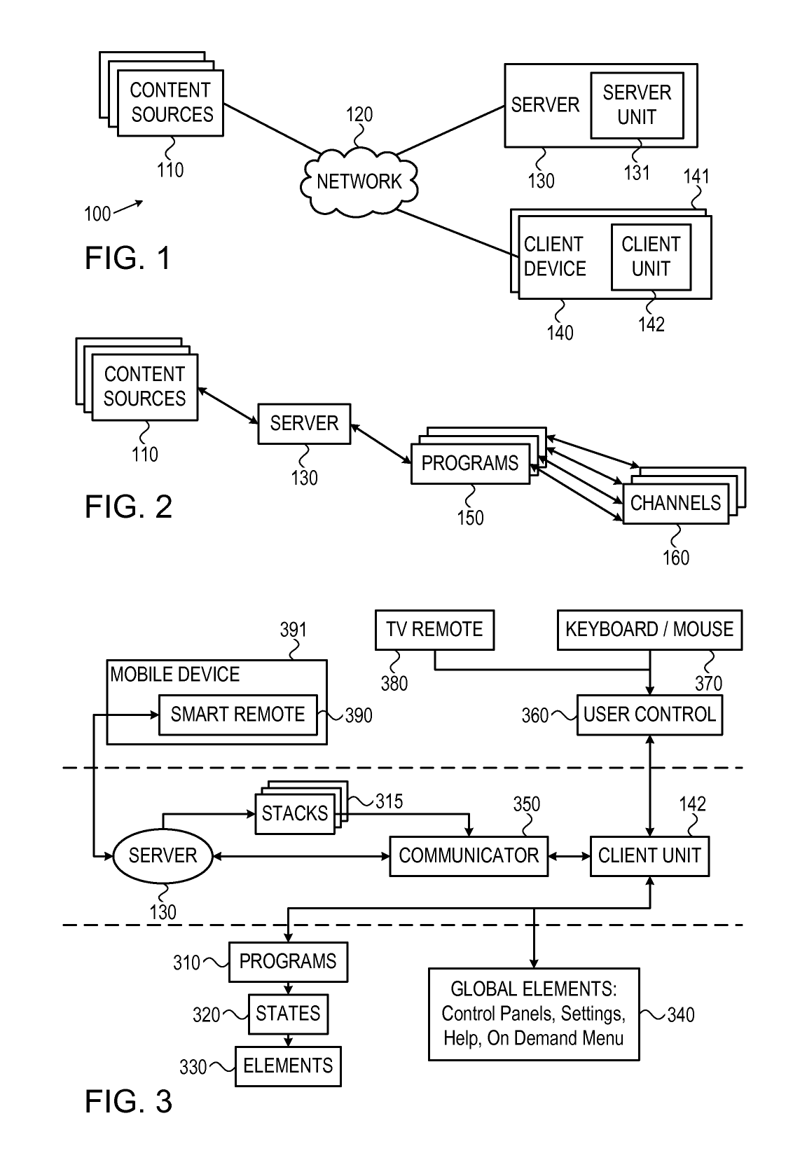

Reference is now made to FIG. 1, a high-level block diagram of a system 100 according to embodiments of the present invention. As shown, system 100 may include a network 120 that may be, may comprise or may be part of, a private or public Internet protocol (IP) network, or the Internet, or a combination thereof. Additionally or alternatively, network 120 may be, comprise or be part of, a global system for mobile communications (GSM) network. For example, network 120 may include or comprise an IP network such as the Internet, a GSM related network and any equipment for bridging or otherwise connecting such networks as known in the art.

As shown, system 100 may include, or be connected to, a plurality of client or user computing devices 140 and 141. For the sake of simplicity and clarity, only two user computing devices are shown, however, it will be understood that a system according to embodiments of the invention may include, or be connected to, any (possibly very large) number of user computing devices similar to 141 and 140.

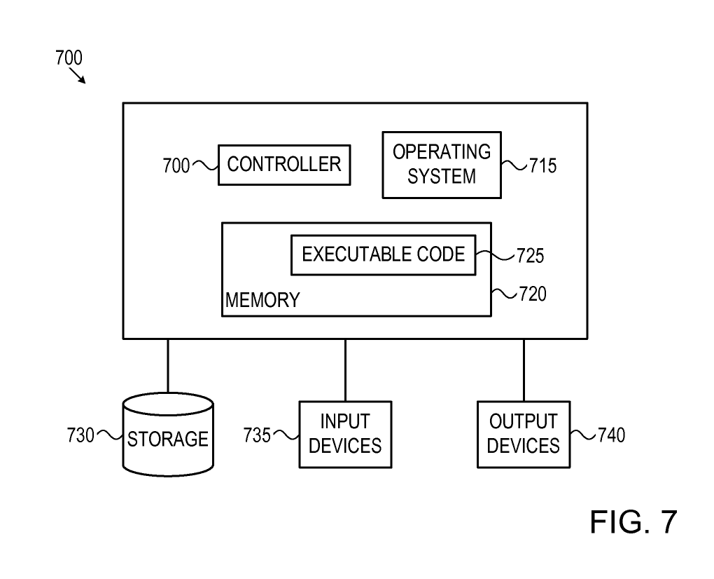

User computing devices 140 and/or 141 may include, or may be, for example, a personal or home computer, a desktop computer, a mobile or laptop computer, a notebook computer and the like. In some embodiments, user computing device 141 may be a network device, a smartphone or a mobile phone or any other suitable computing device capable of at least presenting content received over network 120. In an embodiment, client device 141 may be similar, or include components included in hardware computing device 700 as shown in FIG. 7 and described herein. User or client device 140 may be similar to user or client computing device 141.

In an embodiment, client devices 140 and 141 may be a smart television (TV), connected TV or hybrid TV as known in the art. As known in the art, a smart TV, connected TV or hybrid TV may be a device that provides integration of the Internet (e.g., Web applications or platforms) into a television set or a set-top box connected to a television set. Accordingly, client devices 140 and 141 may be any computing device that provides an interface between computers and television sets or set-top boxes. For example, in an embodiment, a device connected to a regular TV receives input from a user, communicates with server 130 and causes the regular TV set to display content received from server 130. Accordingly, channels and programs described herein may be presented or provided on any TV set.

Server 130 may be any suitable hardware server machine or computer and may be similar to, or include components included in, computing device 700 as shown in FIG. 7 and described herein.

Content sources 110 may be or may include any applicable source of content, e.g., websites, public or other databases, social networks and the like. In an embodiment, content sources 110 may be or may include any content source that can be found on the Internet as known in the art.

For example, content sources 110 may include social graph content that may be, for example, content from a user's wall on Facebook or content is a profile in a social or professional network, update feeds (e.g., activity of friends, photos, videos and statuses shared by friends in a social network), or any information shared on various platforms. For example, social graph content may include tastes in music, upcoming events and the like.

Another example of content included in a channel, program or stack as described herein may be non-video content. For example, textual content obtained from a social network. For example, a 3rd-party application programming interface (API) may be used by data connector 430 described herein to extract, identify or determine events occurring near a user's location. Links that appear in a user's feed may be automatically parsed and crawled (e.g., by data connector 430) in order to obtain additional content. As known in the art, crawling may include automatically obtaining content based on links by a computer. For example, a crawler may be a computer application that uses a uniform (or universal) resource locator (URL) or other address of a World Wide Web page to obtain content. Crawling may include parsing a webpage, finding links to additional web pages in the parsed webpage and obtaining the additional webpages. Any information in a webpage may be used in order to obtain additional data. For example, by following a link to an image, a title of the image may be obtained and used in order to search for additional relevant content or the title itself may be saved as content that may be included in a program, channel or stack.

For example, status updates that contain links to news articles are identified as news headlines articles. A system may then parse these articles, automatically extract relevant images from headlines articles, automatically extract names and logos of the news sources or agencies and include any such discovered content in a program, channel, stack or lineup as further described herein.

Yet another example of content collected may be metadata. For example, a system (e.g., data collector unit 430 in server 130) gathers information related to videos from the various video sources (e.g., YouTube, Vimeo). Other information or metadata, e.g., categories, tags, names, description, popularity and recency may be automatically obtained and may be presented when the content is presented to a user. For example, when presenting a video clip to a user, the system presents metadata (e.g., name of the artist, name of the album, number of downloads on YouTube and the like) collected as described herein.

In an embodiment, only some of the collected metadata is initially presented, e.g., by a title bar described herein. A user may be provided by additional metadata upon request. For example, a title bar that presents metadata may be clickable. For example, clicking on (e.g. using a pointing device such as a mouse or touch screen to indicate the title bar) a title bar may cause a popup window to be presented where the popup window presents additional metadata.

Since a system as described herein may collect large amounts of metadata related to a program or item being presented, not all collected metadata may be presented, rather, metadata may be presented based on user request. For example, using resources described herein, the amount of data that can be collected on an artist may be huge and it may not be desirable to display all metadata on screen when a clip of the artist is played. Accordingly, an element such as a title bar may be configured to provide metadata when clicked on as described herein.

As shown, server 130 may include server unit 131 and client device 140 may include client unit 142. For example, server 130 may be a device similar to device 700 and server unit 131 may be an executable code segment similar to executable code 725. In an embodiment, client device 140 may be a device similar to device 700 and client unit 142 may be an executable code segment similar to executable code 725. Client unit 142 may be any suitable unit. For example, client unit 142 may be a downloadable application that can be executed on the iOS and/or Android operating systems known in the art. Accordingly, client device 140 may be any applicable device, including a smartphone.

Reference is now made to FIG. 2 which shows a high level flowchart diagram and system components that illustrate a system and method for generating or creating content channels according to embodiments of the present invention. As shown, server 130 may receive or obtain content from a plurality of content sources 110. As further shown, server 130 may generate or create a plurality of programs based on content received from content sources 110. As shown, programs may be used to generate channels 160. As referred to and described herein, a content channel (or channel) included in channels 160 may be, or may include, a continuous stream of content. For example, to an extent, channels 160 may resemble television (TV) channels insofar as a user needs not interact with a channel (or a device presenting the channel) in order for content to be continuously provided by a content channel. Otherwise described, a content channel or channel may include a continuous stream of content that may include a plurality of content elements obtained from a plurality of content sources and where the plurality of content elements are of a plurality of content types. Accordingly, a system and method according to embodiments of the invention enable a user to be effortlessly, and continuously, provided with content collected from a plurality of sources.

In an embodiment, content sources include at least one source of text content (e.g., posts on a social network), and at least one video or multimedia content source (e.g., YouTube). A channel generated and provided as described may include both text from the source of text content and videos or multimedia from the multimedia source. Accordingly, in an embodiment, a user is provided with mixed content types (e.g., textual and multimedia content types) in a single channel, program or stack. As further described, various other content types may be included in a single channel program or stack.

As described herein, a system may pull or obtain content from multiple content sources on the Internet (or web) and provide a broadcast experience based on the obtained content. For example, a system may obtain and/or use social graph information, online videos, status updates, tweets, birthdays, news headlines, events, photos or any other suitable content, may pack (e.g., add to a channel) content and data into a 24 hour lineup of programs, stacks or channels. For example, “info” moments and/or other television formats may be used to provide continuous presentation or viewing of content and data.

A system or method may use various methods, rules, criteria, logic and/or algorithms to determine, with respect to a user or with respect to a channel, stack or program, which item or piece of content to feature at what timing, context and placement in a lineup of programs in a channel. The terms program, stack and channel as referred to herein are further described below.

For example, in an embodiment, a system is configured to automatically create TV-like channels out of textual, photographic and video content. A channel may be personalized, designed and generated based on content from a viewer's or user's social context, tastes, locale and the like.

According to embodiments of the invention, client unit 142 enables a user to log into a social network (e.g., Facebook) and client unit 142 (in cooperation with server 130) then automatically starts streaming one or more channels to client device 140. By having a user sign or log into a social network, content related to the user in the social network may be made available to a system. For example, using the user's credentials, server 130 or client unit 142 may access a user's wall in Facebook, obtain content therefrom and include the content in a channel, program or stack.

In an embodiment, client unit 142 receives aggregated content from server 130 and displays the content in a television-based or television-like fashion or format. In an embodiment, server 130 organizes data and content into a lineup. A lineup as referred to herein may be a collection of programs. In an embodiment, each program has a specific design and concept. In an embodiment, client unit 142 presents (e.g., displays and/or plays audio) programs. While presenting a program, client unit 142 may present a variety of elements, such as info tickers (similar to news-channel tickers), sidebars, animated info-graphics, full screen video openers and closers, and more.

Various types of programs (or program types) may be enabled. For example, a program type referred to herein as “info moments” may include short, dense programs which quickly display non-video content, such as top status updates and tweets from social networks, headlines or photos. Another program type may be “video” that may include aggregated video clips or multimedia content alongside other relevant content.

In an embodiment, a system emulates TV's constant flow of content. In an embodiment, client unit 142 requests data and content from server 130 and then presents data and content. Client unit 142 may request data or content in advance, in a manner of ‘laying down the tracks before the train’ such that content for presentation is always available to client unit 142 and thus a continuous stream of content is presented to a user, e.g., in a way or fashion similar to a television channel.

The amount of content (e.g., as measured in time of presentation) that is requested in advance from server 130 by client unit 142 may be configurable or automatically determined. In an embodiment, the amount of data stored or buffered by client unit 142 on client device 140 may be based on a channel or program (or program or channel type) being presented or about to be presented. For example, when or where relevant, client unit 142 only requests, ahead of time, as little information, content or data as possible from server 130 to ensure the newest or up to date content is presented. For example, a channel may provide social network data, e.g., a stream of posts and tweets of friends of the user and client unit 142 may periodically request additional content in the program so that up to date content is provided from server 130 and thus buffering of possibly outdated content is avoided.

By only requesting small amounts of data at frequent intervals, client unit 142 may cause the last or most recent posts and tweets to be presented to a user as a stream of posts and tweets. In another case, e.g., when providing on client device 140 a channel that provides continuous music clips, client unit 142 may buffer larger amounts of data on client device 140. For example, a relatively large number of clips selected based on a genre may be buffered. Accordingly, bandwidth and computing resources may be reduced when possible while, when needed, real-time attributes may be observed. In yet other embodiments, client unit 142 may register for specific events at server 130 and, based on the registration, content may be pushed to client unit 142, in real-time. For example, a news channel may present content to a user where the content is collected, in real-time, by server 130 and pushed to client unit 142. For example, tweets collected or obtained from twitter may be pushed to client unit 142 while a news channel is presented to a user. Accordingly, a user may be provided with real-time data even though the user is not actively searching for the data, e.g., the user is watching a program and real-time data is automatically collected and presented to the user using push scheme. Pushed real-time data described herein may be presented in a dedicated area of a screen, by a popup window or by any other suitable means as described herein.

In an embodiment, e.g., in order to minimize loading and/or user waiting times, client unit 142 pre-fetches static media needed, as well as assembles the display elements for the next program, such that viewing (or presentation) of two or more programs in a channel can be continuous or uninterrupted. In an embodiment, server 130 may have full control over what programs are played or included in a channel and in what order programs in a channel are presented. In another embodiment, e.g., when presenting an on demand program, client unit receives input from a user and requests a specific program or content, skips or fast-forwards a portion of a program, rewinds a presentation and the like.

In an embodiment, if client unit 142 (or server 130) has no content to present (e.g., during a startup phase) predefined sources may be used to quickly generate or obtain data for presentation. For example, pictures of the user may be presented (e.g., from a buffer or from a user's Facebook account). Accordingly, time slots may be filled with preconfigured or pre-selected content such that a channel or program is never in a state where no content is presented. For example, during an initial phase, content such as user's photos may be presented to cause an effect similar to a transition between programs seen on traditional TV channels. Pre-configured sources (e.g., a user's Facebook wall) may be used in order to fill time slots. For example, server 130 may access a user's Facebook account, pull any content based on any criteria therefrom and provide the content to client unit 142 that may display the content as a stream of content items.

Client unit 142 may include a component that stores data received from server 130. Client unit 142 may include a component that keeps track of a viewer's position in a lineup, channel, program or stack and fetches additional content from server 130 when needed. Server 130 may include a component that constructs programs (or program objects). In an embodiment, a program or program object encapsulates element objects. An element object in a program may include the specific display components that characterize program. A program selected for presentation (also referred to herein as the “active program”) renders its content (e.g., based on element objects and defined layouts in the program) on a screen of client device 140.

In an embodiment, a component included in client unit 142 tracks user location or position in a program, receives user inputs, and processes the inputs to determine an action. For example, based on a user input and/or user position in a lineup, a component in client unit 142 may communicate with server 130, e.g., in order to fetch additional content.

In an embodiment, a program object manages its elements, components or sub-components such that content is presented or provided according to a style defined for, or associated with, the program. Various elements may be included in a program. For example, constant elements may be a channel logo, a watch showing the current time, a visual representation of the weather or of the network health or other information. Another example of an element in a program is a title bar that may be displayed when a video is displayed (e.g., at the bottom of a screen of client device 140).

A program object may manage, and/or switch between, several states. A state of a program may include and/or dictate different presentation layouts and/or dynamic behavior for the elements in a program. For example, parameters in a program may determine the timing according to which elements appear on screen (or played by speakers attached to client device 140). For example, in response to user actions such as touch or moving a mouse, a program switches active elements or states. For example, based on a mouse click, an element may be stopped from presenting content and another element may be activated. In another example, if a program runs out of relevant data for presentation the styling and rendering of the elements may be changed or a transition to an element that presents buffered or backup content may be made. Likewise, positioning, coloring, etc. may all be managed by a program object, e.g., based on parameters and configuration data in a program. As described herein, in an embodiment, a program is generated or created by server 130 and presented or executed by client unit 142 or under control or client unit 142.

In some embodiments, similar to television programs, programs may begin with an ‘opener’, a short, fullscreen, video clip which transitions the viewer from the previous program, and firmly places the user into the new or next program in a channel. In an embodiment, following an ‘opener’ or transition clip, a dynamic part of a program begins where content is displayed according to a unifying program related theme. In an embodiment, when terminating presentation of content, a program ‘closer’ is presented, e.g., a short video clip that may serve to signal the transition from the current program to the next program.

In an embodiment, a program has a unique visual identity that can be defined or identified by color coding, textures and audio such that one program is differentiate from another program. A general and noticeable graphic design or theme may be kept for all channels or programs such that channels and programs presented by a system are easily identified, and/or associated with a system according to embodiments of the invention.

A program may be associated with, or generated based on, a theme. For example, themes such as ‘The Comedy Strip’ or ‘Music Non Stop’ may be associated with a program. In an embodiment, server 130 collects, aggregates and/or creates content needed for a program and client unit 142 presents (or manages a presentation of) a program provide by server 130. As described, presentation of a program may be according to a specifically or uniquely designed format. For example, a set of programs titled top stories, fresh picks, comedy strip, new albums, music non-stop and celeb TV may be provided where each of these programs is provided using a specific theme. For example, a theme may include or define specific background music types, background colors, layouts, specific transitions from one content item to another and the like.

Programs that mainly include video clips or video content (also referred to herein as “video programs”) may be presented based on various layouts. Generally, a layout may define the type, size, orientation and/or placement of the various elements which are displaying content. For example, a layout may define the size and area on a display which are dedicated for presenting a video clip. A layout may be defined in a program (e.g., as metadata included in a program and associated with an element such as a video clip). In an embodiment, a layout, size and area of video display, background colors or music are all defined by parameters included in a program object generated by server 130 and provided to client unit 142. In an embodiment, client unit 142 is configured to examine parameters in a program object received from server 130 and present the program based on the parameters. In another embodiment, elements in a program are configured to present content according to parameters in the program and thus, a program may be presented with minimal intervention or control of client unit 142.

Client unit 142 may include or may interact with a video player that may be a module or application adapted to present multimedia as known in the art. Based on parameters in a program or based on other configuration parameters, the mode of presentation of video (e.g., fullscreen or other as known in the art) may be controlled by client unit 142 or by an element in a program.

A number or plurality of elements in a program may present content simultaneously. For example, a first element may present a video clip (or a stream of video clips) and a second element in a program may control (and present content in) a title bar. A title bar (e.g., titled ‘Now Playing’) may be presented at the bottom of a display, possibly partially overlapping a video presentation and may display metadata, e.g., the name of the video, its duration, its source, social context information, such as “likes” or number of downloads or any other data. Accordingly, a program may include a first element that may be present previously received content and a second element that may present real-time or other data or metadata related to the content presented by the first element.

An element presenting metadata (e.g., a title bar) may be interactive. For example, when clicked on, a title bar that presents metadata may present additional metadata or link to another website or application. For example, a title bar may present the name of a currently played video clip and, when clicked on, the title bar may present number of downloads, number of likes, length of the video, information related to the artist etc.

Another example of an element may be ‘Stickers’ that may present small animated graphics which provide further insight into why a video clip was selected to be included in a program. For example, a sticker overlaid on a video or presented elsewhere on a display may read ‘1 million view on YouTube’ or ‘Fresh Picks’ or indicate the video clip is brand new content which was created recently, etc. Accordingly, presentation of content may include presenting of the actual content and presenting information related to the content, e.g., information related to a video clip collected from the Internet.

Another example of an element may be a sidebar element (e.g., titled ‘Coming Up’) which is designed to anchor the user to a lineup by displaying information related to upcoming videos, content or programs. A side bar may include teasers or information designed to attract a user to request a specific program. For example, based on a user profile or user preferences, specific programs may be advertized in a sidebar. Accordingly, when presenting a content object, a system may search (e.g., on the Internet) for content, data or metadata related to the content object, may obtain related data, metadata or content, and may display or present related data, metadata or content while presenting the content object. In another embodiment, a sidebar elements executed on client device 140 contacts server 130, obtains from server 130 a list of up coming programs in a channel and presents, to a user on client device 140, information related to up coming programs.

In yet another embodiment, an element receives from server 130 ratings of users and presents to a user related information. For example, client units 142 on a plurality of client devices 140 receive ratings (e.g., likes or other form of rating data) from users and send rating information to server 130. Server 130 aggregates users' ratings and, upon request, provides the ratings. Accordingly, in an embodiment, an element in a program may present to a user information such as top or most popular programs viewed by other users of system 100.

As described, content such as video clips or a stream of images may be presented while other content is being presented. For example, social related content and/or non-video content may be presented at the same time, and on the same display, a video clip is presented. For example, in an embodiment, non-video content is overlaid on a video content. In another example, a first area of a display is assigned or allocated to video, and a second area of the display is assigned or allocated to non-video content.

Non-video or non-multimedia content presented at the same time and on the same display multimedia is presented may be of any applicable type. For example, in an embodiment, while a video clip is presented, tickers are displayed by elements in a program. For example, tickers similar to 24 hour news channel tickers known in the art may be presented. Tickers may be placed or presented at the bottom of a screen, and may provide up to date textual content from any source, e.g., a user's social feed. For example, a ticker may present content collected based on a user's Facebook account. For example, posts made by social network friends or circles related to the user may be presented in a ticker, while a video clip is presented. Status updates, commentary on news articles (e.g., dubbed Headlines), Birthdays and upcoming events may all be displayed by tickers as described herein.

For example, in an embodiment, a user of client device 140 provides client unit 142 with credentials (e.g., user name and password) and client unit 142 (or server 130) uses the user credentials in order to retrieve data from a social network. For example, server 130 identifies birthdays or posts of friends of the user and causes a ticker to display relevant information by providing the ticker with relevant data. Accordingly, in an embodiment, a ticker or other element in a program displays data such as, but not limited to, upcoming birthdays (and relevant names) of friends of a user, posts over social networks, news retrieved from news sites on the Internet etc. Accordingly, elements such as tickers may constantly and continuously present any information on a display screen, possibly alongside other content. As a result, a user may be provided with a TV channel like presentation or experience, where, unlike a TV program, the content presented in a program according to embodiments of the invention is collected, possibly in real-time, from a plurality of sources that may include any type of source that is reachable over a computer network.

In an embodiment, sidebars are presented, typically while other content types in a program are being presented. For example, in an embodiment, a sidebar element presents social related content. In an embodiment, utilizing a screen space larger then used by a ticker, a sidebar element may show information related to friends or circles in a social network, e.g., the latest photo updates, birthdays occurring today and tomorrow, and events happening today. Accordingly, rather than actively searching for, or retrieving, social network information, a user may be presented with relevant social network information while, at the same time, videos or other content in a selected program is presented.

Elements such as sidebars and tickers may be included in a program but may be configured differently for different programs. For example, the size, location and frame of a sidebar when included, or presented, in a “Music Non Stop” program may be different from the size, location and frame of the same sidebar when included, or presented, in a “News” program. The content of a sidebar when included, or presented, in a first program may be different from the content of a sidebar when included, or presented, in a second program. For example, when included in a “News” program a sidebar may display photos of people and events related to recent events or news and when included in a “Music” program, a sidebar may display photos of artists or performers, e.g., present photos of singers liked by friends of a user (e.g., friends or circles in a social network), birthdays of celebrities, upcoming music events taking place in the user's geographic area and the like. It will be understood that by having access to the Internet (e.g., by server 130 and client unit 142) a system may obtain any information readily obtainable on the Internet. Accordingly, it will be understood that elements in a program may present any information that is available on the Internet or web as known in the art.

Another example of non-video content may be an info-moments element in a program. For example, in an embodiment, an info-moments element or object presents or provides a quick view into the newest and most interesting content available as selected based on preferences of a user or selected based on analyzing user actions and selections, preferences of friends or circles in a social network and the like.

For example, trending topics, important statuses, spotlights on specific persons/topics in the user's social graph may be presented by an info-moments object. In an embodiment, an info-moments object presents animated photos and text, while further displaying to the user items' source and context. For example, a name of a web site from which content was obtained, number of “likes” associated with a content item presented, comments or any other social graph related data are presented by an info-moment element or object in a program.

Reference is made to FIG. 3, a high level block diagram of a system and flows according to some embodiments of the present invention. As shown, a system according to embodiments of the invention may include, or may interact with, a user control 360. User control 360 may be any suitable unit, module, sub-system or component enabling a user to interact with client unit 142. As shown, user control 360 may enable a keyboard and mouse 370 a television remote control to communicate with client unit 142. User control may mediate between components that use different communication protocols. User control may receive signals from a remote control 380 over a Wi-Fi network, process or convert the signals and send relevant signals or data to client unit 142 thus mediating between client unit 142 and a control or other device.

Other input devices, e.g., a touch screen or pad, a universal serial bus (USB) device or any other suitable input device may be operatively connected to user control 360. It will be recognized that any suitable number of input devices may be operatively connected to computing user control 360.

Mobile device 391 may be a user's smartphone, tablet, laptop or any suitable mobile device. In an embodiment, mobile device is connected to network 120. Smart remote 390 may be any unit, module or application used to control, or interact with, a system according to embodiments of the invention. In an embodiment, smart remote 390 provides, on mobile device 391, functionalities similar to the functionalities provided by client unit 142 on client device 140.

Server 130 may relay communication between client unit 142 and provide smart remote 390 with any data or service provided to client unit 142 as described herein. Accordingly, it will be understood that client unit 142 and smart remote 390 may freely communicate. For example, smart remote 390 may determine the program being presented on client device 140 by querying client unit 142 (or server 130), may request client unit 142 to skip forward, change channel and the like.

In an embodiment, instead of using server 130 for connecting mobile device 391 to client unit 142, an additional relay or bridging server (not shown for the sake of clarity) is used. In the embodiment, mobile device 391 connects to a bridging server that is adapted to relay messages. For example, long term connections are established between a relay server and mobile device 391 and between the relay server and client unit 142 such that events generated by mobile device 391 are immediately transferred to client unit 142. Similarly, events from client unit 142 are relayed to mobile device 391 by the relay server. Accordingly, any operations related to relaying messages between mobile device 391 and client unit 142 described herein with respect to server 130 may be performed by a relay, bridging or other dedicated server.

Smart remote 390 and client unit 142 may log into a user account (e.g., using credentials provided by the user). For example, smart remote 390 and/or client unit 142 may log into a user's Facebook or Google+ account. In an embodiment, smart remote 390 maintains a connection with the client through an intermediate socket based server (e.g., server 130). This allows to easily enable mobile device 391 to work through any type of network to which mobile device 391 and client device 140 are connected to. Both ends can be connected on the same network or not. In an embodiment, a two-way network continuous connection is used to pass both content from client device 140 to mobile device 391. By using server 130 (or another server) as a relay between client device 140 (and/or client unit 142) and smart remote 30, an embodiment ensures that server 130 (or another server) can be made aware of the communication.

For example, server 130 may determine a response to a request from smart remote 390 can be provided by server 130 and, accordingly, provide the response or, server 130 may forward a request to client unit 142. For example, while server 130 may know which program is currently presented on client device 140, server 130 may need to query client unit 142 as to which global element is currently active on client device 140. Accordingly, server 130 may examine requests or data received from smart remote 390 and from client unit 142, may respond to queries or may forward queries between smart remote 390 and client unit 142. As discussed, server 130 may process any input or message received from smart remote 390 and client unit 142 and may, based on the processing, send one or more messages, requests, commands or other data to smart remote 390 and/or client unit 142.

As shown, a communicator 350 may handle communication between client unit 142 and server 130. For example, communicator 350 may handle authentication of a user, e.g., when logging into server 130, reports and statistics. In an embodiment, communicator 350 receives requests from client unit 142 and forwards the requests to server 130. In the reverse direction, communicator 350 may receive messages from server 130 and forward messages to client unit 142. Although communicator 350 is shown as a separate unit, other configurations may be contemplated. For example, in an embodiment, communicator 350 is included in client unit 142. For example, client unit 142 may be an application and communicator 350 may be a module or unit in the application.

As shown, client unit 142 activates, controls or manages programs 310. As shown, a program may be associated with one or more states 320 and elements 330. As further shown, client unit 142 activates, controls or manages global elements 340. As shown, stacks 315 are generated and maintained by server 130 and data in stacks 315 is provided to client unit 142. As described herein, in an embodiment, any one of elements 330 associated with a program 310 may request (or be otherwise provided with) data in stacks 315.

Stacks 315 may generally be any construct or object, e.g., a list or table that includes a plurality of ordered content items. As referred to herein, a stack may be any object that can store content items and further enable retrieving or extracting content items therefrom. For example, a server may insert or push a content item into a stack and a user device may extract or pull the content item from the stack. As referred to herein, a content item may be any digital object, For example, a content item may be a video clip, an image, a text string and the like. For example, a stack related to news may include a plurality of information elements (e.g., text and images) related to recent events or topics.

A stack related to music may include a plurality of content elements related to musical trends, images of popular artists and the like. Any data source (e.g., web sites or social networks) may be used in order to include data or content elements in a stack. For example, server 130 may be configured to search the Internet in order to find content relevant to a specific stack. Server 130 may register with relevant platforms or services (e.g., Rich Site Summary (RSS)), receive news, updates or other content and include received or otherwise obtained content in stacks 315. In general, server 130 may be configured to carry out methods as described herein. For example, server 130 may include a controller 705 (FIG. 7) which executes software or code to carry out embodiments of the invention.

In an embodiment, stacks 315 include displayable data as provided by server 130. A system may provide various types of stacks. An exemplary stack may be a generic stack that includes statuses, birthdays, events and the like. Some of stacks 315 my be program specific stacks. For example, a stack suitable for a celebrity channel or program may include funny tweets by comedians or celebrity birthdays.

In an embodiment, new items are added to a stack included in stacks 315 by, or when received from, server 130. In an embodiment, elements 330 request content from stacks 315. Stacks 315 may include a management unit. In an embodiment, each stack in stacks 315 includes, in addition to content for presentation, a management unit or module. For example, a stack may include, be installed in or executed by, a computing device similar to 700. In another embodiment, a stack in stacks 315 may be managed by executable code similar to 725 and a single or plurality of code segments may manage a plurality of stacks, thus, a plurality of stacks 315 may be supported by a single computing device, e.g., by server 130. In general, managing and maintaining a stack may include maintaining one or more lists or tables, recording order of items in the stack, inserting and removing content items into/from a stack and responding to requests by providing content items from a stack.

Various elements may be used to automatically present content. As described, an element in elements 330 or global elements 340 may be a script, program or any executable code that may autonomously obtain data and present obtained data. Exemplary elements may be tickers, e.g., a birthday ticker, a status ticker, a headlines ticker, or an events ticker where each ticker obtains and presents information related to a specific field or context. Sidebars may be another example of an element in a program or in global elements, e.g., a “coming up” sidebar, a photos sidebar, a friends' likes sidebar, a birthdays sidebar and the like.

In an embodiment, requesters request (from a stack) one or more items to display or present, and the stack then supplies the requester with the freshest (e.g., added or produced most recent in time) items that haven't been displayed yet by the requestor. For example, a stack keeps a list of displayed items or items previously requested by a specific requestor and uses such list in order to select items to send to a requestor. A requestor can ask to reset the list when all items have been displayed, thus repeating older content that might have been missed by the user the first time. A stack can return only data that matches specific criteria passed by the requestor. For example, stacks 315 may support constraints such as limits on an age of an item (e.g., date a content item was created), who an item is related to etc. As described, a management unit may maintain any information related to a stack and to content in a stack. Accordingly, any metadata related to content items in a stack may be available to a stack management unit. Accordingly, any criteria may be received from a requestor and used in order to select content items from a stack.

For example, in an embodiment, a status ticker described herein simply requests a number of items from a stack, and displays items received from the stack. The next time a request for statuses is received, the newest items in the stack (e.g., items inserted into the stack after the last request from the status ticker) are selected and provide to the status ticker element in program 310. Next, the stack (or management unit in the stack) selects yet unseen items, e.g., items or elements in the stack not yet sent to the specific requestor. In order to select items, a stack may keep a history track for each requestor thus a stack can select items not yet provided to a specific requestor. Other embodiments may shuffle and reuse stack items so that a user may be provided with content elements more than once but in dynamically changing order. It will be understood that any logic or algorithm may be used in order to select items from a stack.

Any applicable content types may be included in stacks 315 and stacks may be designed and dynamically created for any applicable subject, field or purpose. A stack in stacks 315 may be a global stack that may be suitable, or used for, a group of users or all users. For example, a news stack may provide headline news and thus may be suitable for any user or any element in a program that requests news. A stack in stacks 315 may be global or may be user specific. For example, a stack may be associated with a specific user and may include content specifically collected for the specific user. For example, a system may include a birthdays user stack that includes content items related to birthdays of friends and family of the user. A system may include a birthdays global stack that includes content items related to birthdays of celebrities. Other examples of stacks in a system may be an events stack that includes content related to recent events or events related to a specific field of interest (e.g., a system may include a plurality of event stacks related to events in a respective plurality of fields). Other stacks may be stack of photos (e.g., related to a specific user or a specific topic), a stack of headlines and the like.

A system may enable a user to share a channel, a program or an element in a program. For example, a user can share what he or she is watching right now using a system according to embodiments of the invention. In an embodiment, a single click by a user may trigger an event that is interpreted by a system and causes the system to share content provided by the system to a user with other users.

In an embodiment, a button (or other suitable graphical user interface (GUI) object) is presented on a display and when pressed by a user, causes the system to share the current program or element with friends or circles in a social network. For example, user control 360 may present the GUI element, receive or identify a click on the GUI element and inform client unit 142 of the click and the element associated with the click. Provide with a user selection, client unit 142 may, for example, add a link to a content item currently presented to the user to the user's Facebook wall. Other form a of sharing content, e.g., as supported by social networks may be supported.

Generally, provided with any required user credentials (e.g., user name and password as provided by a user to client unit 142), client unit 142 may perform any action or task on behalf of the user. Accordingly, it will be understood that any action (e.g., sharing content in a social network) that may be performed by a user may be performed by client unit 142 on behalf of the user. User input may cause client unit 142 to include an item in a favorites list (not shown). A favorites list may be a list maintained on server 130 or by client unit 142. A channel that (possibly only) includes items in a favorite list may be generated. For example, items in a favorites list may be included in a program or stack as described herein.

An item shared by a system on a social network may be viewed by users, e.g., by clicking the item as known in the art. A link added to a wall of a user may be generated such that when clicked, it points a web browser to server 130. Accordingly, in an embodiment, users clicking on the link will be redirected to server 130. If the user who clicked the link is logged into his or hers own account in server 130, the shared clip will be played or presented by their respective client unit 142. For example, a clip shared by a first user is presented to a second user, accompanied by social network content related to the second user. As for unregistered users, server 130 may provide the shared content and further prompt the users to register with server 130.

A system may provide content on demand. For example, in an embodiment, a system enables a user to navigate within the lineup of programs. For example, server 130 may generate and arrange programs in lineups of programs. In an embodiment, a lineup (or program lineup) includes a set of ordered programs that may be provided, according to the order of the lineup, to users. A channel may be or may include a lineup of programs. Client unit 142 may receive an event from a user indicating the user wants to skip to the next program in a lineup, rewind to the beginning of a program, skip three programs ahead, etc. It will be understood that any other navigation in a lineup may be supported, e.g., in a way or fashion similar to video on demand (VOD) as known in the art. For example, if a program in a lineup requested by a user is not buffered by client unit 142 on client device 140 then client unit 142 may request the specific program from server 130 and may present the requested program to the user. In an embodiment, a web interface is provided, enabling users to directly interact with server 130. Accordingly, it will be understood that any functionality associated with client unit 142 may be performed by server 130 when interacting directly with a user when the user users a web based interface. For example, navigating in a lineup, setting preferences, selecting a program and the like may all be done by directly interacting with server 130 using a web browser as known in the art.

Server 130 may crate a program based on user input. For example, based on keywords entered by a user (e.g., via user control 360), server 130 may create a program and the program may be provided to the user. For example, based on keywords, server 130 (or client unit 142) may search for content in social networks such as Twitter or Facebook. Other web sites, sources or services, e.g., YouTube may be searched fro content matching user provided keywords or input and programs may be created based on content retrieved using keywords or other search criteria. The same set of keywords may be used over and over again, accordingly, a plurality of programs may be generated based on a single set of search terms.

Global elements 340 may include elements that function for more than one program. Accordingly, global elements 340 may be referred to herein as cross-program elements or as service elements. A service element may be a module (e.g., a software application, a JavaScript and the like) that provides services to programs or elements in a program. For example, an element included in global elements 340 may be an audio manager, module or unit. In an embodiment, an audio manager provides or supports a variety of audio services, modes, schemes or methods. For example, an audio manager may play a sound effect, or play background music. In an embodiment, programs request services from an audio manger and may associate a service with an event. For example, in an embodiment, a program links in a sound effect to an event and accordingly, the sound effect is played each time the event occurs. In another case, a program requests background sound and may also indicate a set of clips which will be played by the audio manager (e.g., in a loop). An audio manager may terminate a service based on a termination of the requesting program, based on a command from client unit 142 or based on any applicable event.

In an embodiment, user control 360 provides an interface between a user and a system. User control 360 may be configured to receive events or data from user input devices, e.g., keyboard and mouse 370 and/or TV remote control 380, process events and data received and, based on the processing, send events and/or data to client unit 142. Client unit 142 may process data received from user control 360 and, based on the processing, interact with a program, an element in a program or an element included in global elements 340.

Accordingly, a system may respond to user input based on configuration or logic. For example, based on a configuration or logic of client unit 142, pressing the “up” key on a keyboard may cause any effect (e.g., skip to next program in a channel or lineup of programs). By processing input from a user using any known in the art input device (e.g., connected to user control 360 as described), an embodiment is able to associate any input from a user with any one or more actions. For example, a specific keyboard key pressed may cause client unit 142 to switch channel.

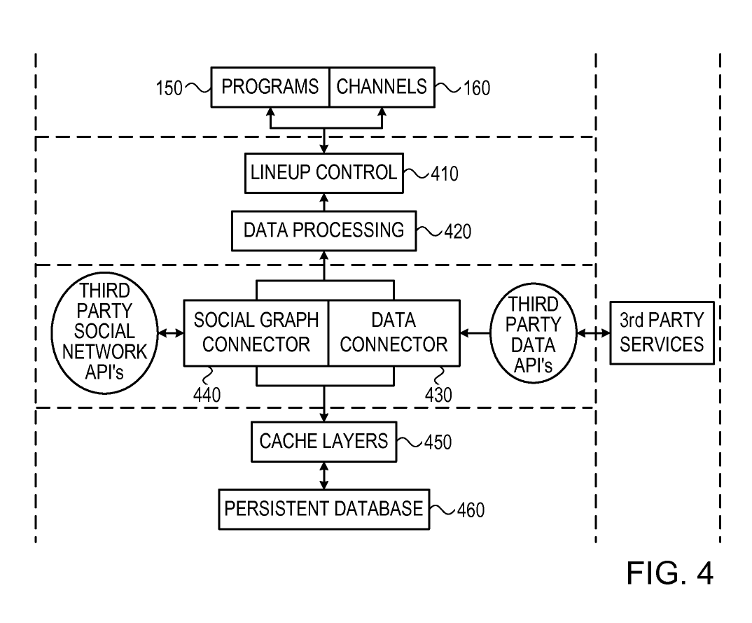

Reference is made to FIG. 4, a high level block diagram of a system and flows according to some embodiments of the present invention. As shown, a system for generating and providing programs 150 and/or channels 160 may include a lineup control unit 410, a data or content processing unit 420, a data connector 430, a social graph connector 440, cache layers 450 and persistent database 460. In an embodiment, server 130 includes lineup control unit 410, content processing unit 420, data connector 430, social graph connector 440, cache layers 450 and persistent database 460. In an embodiment, server 130 uses data connector 430, social graph connector 440 to collect and integrate data from various data sources on the Internet using third party application programming interface (APIs), third party social network APIs and/or third party services as shown. For example, using an API, social graph connector may obtain any information related to a member or user of a social network. For example, social graph connector 440 obtains posts made by friends of a specific user in a social network and these posts are inserted into a program generated for the user. In another example, social graph connector 440 obtains posts made by friends of a specific user in a social network and these posts are inserted into a stack described herein or are provided to an element in a program, the element executing on the client device of the relevant user.

Accordingly, in an exemplary scenario, while a user is watching a program or channel described herein, server 130 queries social networks and online services, collects, aggregates, processes and/or filters data and content related to the user (e.g., posts of friends, news related to a field of interest and the like) and provides content to the user. Accordingly, a system may dynamically and possibly continuously collect content for a user and provide or stream the content to a user. Content collected by social graph connector 440 and data connector 430 may be, for example, online videos or online video catalogs, textual content such as RSS feeds or posts, photos from photo databases or other sources and the like. It will be understood that any content of any type may be collected by social graph connector 440 and data connector 430, processed by data processing unit 420 and, and included in programs 150 or channels 160.

In an embodiment, a channel includes or is otherwise associated with a plurality of programs. For example, as shown by the arrows connecting blocks 150 and 160, a number of programs 150 may be associated with, or included in, a channel 160. Accordingly, when a user selects a channel, the user is provided with a set of programs in the channel. For example, server 130 generates a number of programs 150 and associates the programs with one of channels 160. In an embodiment, server 130 generates programs based on characteristics of a channel. For example, server 130 may generate a plurality of programs for a celebrity channel by collecting, from any available source, data related to celebrities and may generate programs for a news channel by collecting, from any available source, data related to current events etc. Accordingly, although not specifically shown in FIG. 1, a channel may include a plurality of programs, e.g., similarly to the way a TV channel includes a plurality of programs.

A system may automatically create a lineup of programs and include a lineup of programs in a channel. For example, a lineup of programs in a channel may result in a channel that, as viewed by, or presented to, a user, is similar to a TV channel. By automatically and continuously collecting data from various sources such as a social network or web sites on the Internet as described, a system may automatically and continuously generate content, include the content in programs and/or stacks and provide such dynamically collected or generated content to a user in a fashion that resembles TV channels, programs or broadcasts. By providing content collected from sources such as the Internet and/or social networks in the form of continuous channels or programs as described, a system enables a user to be effortlessly and continuously be provided with content that would otherwise require the user to be active. For example, using the system described herein, in order to track or follow posts of friends on a social network, a user may simply tune in to a dedicated channel or program, or, while watching a news channel, activate a ticker or sidebar configured to deliver social network content and be thus provided with friends' posts.

Data processing unit 420 may aggregate, filter and/or perform any processing on content collected by data connector unit 430 and social graph connector 440. Data processing unit 420 may exclude or filter out content. For example, based on a criteria or rule, specific content types may be excluded such that they are not included in a program or channel. For example, content unsuitable for young children may be excluded from a channel designed for young age. Content may be excluded based on a user preference. For example, a user may indicate that he or she is not interested in seeing posts from a specific friend in a social network. Accordingly, data processing unit may filter out posts made by the indicated friend and, accordingly, while including posts from other friends, a channel, program or stack my not include posts of the indicated (or banned) friend.

Data processing unit 420 may examine, filter or process data collected based on any relevant parameters, events and information such as, for example, likes, social circles, friends of friends, interests, location, popularity, categories, key words (tags) in order to determine whether or not a content item is to be included in a program or channel. If a content item, element or object is selected to be provided to a user then it may be included in a program, channel, stack or otherwise provided to a user as described herein.

A content element, object or item may be selected to be presented (e.g., in a program or channel) multiple times. A content element, object or item may be selected to be presented in a plurality of different programs or channels, may be inserted into a plurality of stacks in stacks 315 or it may be inserted more than once into the same stack. For example, in an embodiment, lineup control unit inserts content items into programs, channels or stacks.

In an embodiment, lineup control receives requests from client unit 142 and makes sure a continuous stream of content is provided to a user by lining up content for presentation. For example, lineup control unit 410 makes sure at least one program is ready for presentation immediately after the program currently presented to a user ends. In an embodiment, client unit 142 requests a program from lineup control unit 410, e.g., when client unit 142 determines the currently presented program is about to end. Accordingly, a continuous, uninterrupted stream of programs is provided thus a TV like channel is achieved where the content presented by a channel is dynamically and continuously collected from various sources as described. Based on system configuration or other parameters (e.g., the speed with which content can be downloaded from server 130 to client device 140), client unit 142 may buffer content. For example, while a first program is presented on or by client device 140 client unit may download and buffer a second program so that a smooth and uninterrupted sequence of programs is presented to a user.

In an embodiment, a program is assigned or associated with a program identification (program ID). An object associated with a channel (e.g., a list or table) may include the program IDs of programs in the channel. Client unit 142 may inform server 130 (e.g., lineup control unit 410 when installed on server 130) of the program ID of the currently presented program thus enabling server 130 (or lineup control unit 410 thereon) to determine where, within a channel or lineup of programs, the presentation of content on the client device is. Lineup control unit 410 may decide which program comes next, e.g., based on a lineup of programs in a channel.

Programs may be generated on-the-fly or in real-time. For example, if server 130 does not have enough content in order to generate a specific program, server 130 may decide to either complement or generate a program using predefined content sources (e.g., collect content from predefined sites, include in a program content items included in other programs and the like). In another case, e.g., when not enough content is available, lineup control unit 410 may skip a scheduled program and send the one after in line to client device 140.

Programs may be provided on demand. For example, based on input from a user, client unit 142 may request a list of programs from server 130 (e.g., programs generated by data processing unit 420 or arranged in a lineup by lineup control unit 410). Client unit 142 may present available programs to a user, receive a selection and use a program ID in order to request the program from server 130. Accordingly, an “on demand” service may be supported with respect to programs described herein.

A program may be associated with a theme. For example, preconfigured programs such as comedy strip, celeb TV, etc. may be associated with a theme that includes background themes or colors, background music, transitions between elements and the like. Lineup control unit 410 may associate content elements with programs based on matching metadata associated with the content element and a theme of a program. For example, in an embodiment, lineup control unit 410 examines metadata of a content item (e.g. tags or categories associated with clips as known in the art) and determines, based on the metadata and a theme of a program, whether or not the content item is to be included in a program. For example, based on a match of metadata of a content and a theme of a program, the content item may or may not be included in the program.

When generating a program for a specific user, data processing unit 420 and lineup control unit 410 may examine any information related to the user. For example, based on likes posted by a user (as collected by social graph connector) or any other actions or behavior of the user, data processing unit 420 or line control unit 410 may include/exclude content in/from a program or lineup of programs. For example, social graph connector 440 may learn or determine a user's taste by analyzing likes or video clips selected by the user. Likes, skips of video clips or other content items in a program, requests for on demand content may all be examined, recorded and processed (e.g., using statistical processing) in order to identify or determine user preferences or taste. Accordingly, when choosing programs or content to be included in programs (or stack or other forms of providing content described herein), a system may use automatically determined user preferences.

Preferences or attributes of a user's friends or contacts may be take into account when profiling a user or when to determining the user's preferences or taste. For example, if a close friend of a user (determined by noting the user often exchanges data with the friend) has certain interests and tastes, lineup control unit 410 may include, in a program generated for the user, content based on preferences of the user's friends or contacts. Content items may be scored or ranked and inclusion of content items in a program or stack may be according to a score or rank. For example, a first score may be associated with a content item “liked” by a user and a second, lower score, may be associated with a content item “liked” by a friend of the user.

A program may be any construct that includes or references content items. For example, a program may be a file that includes the actual video clips or other content as well as any relevant metadata, e.g., a list of the content items in the program. Accordingly, after content is selected for a program, server 130 may package the content into a program, and, based on a request from client unit 142, server 130 may send the program to client device 140. In an embodiment, server 130 generates a plurality of programs such that a lineup of programs is created. Programs in a lineup may be sent to client device per request or the may be “pushed” to client device 140 so that client device may buffer programs thus ensuring continuous content delivery that resembles content delivery as seen in TV channels.

To further enable serving programs continuously, in a way that emulates content delivery by TV, server 130 may include several layers of data storage, e.g., as shown by cache layers 450 and persistent database 460. For example, cache layers 450 may include content items recently used or provided and persistent database 460 may store users' data, profiles, preferences and the like. Accordingly, programs may be generated based on cached data and based on user specific (per-user) data. Different types of data may be stored in cache layers 450 differently, based on their relevance nature. For example, video related information tends to be relatively static so server 130 may store or cache information related to video clips for a few days. Any other considerations may be applied to storing data, e.g., user preferences, time to live (TTL) as known in the art and the like.

For example, social information (e.g., current location or activity) may quickly become outdated. Accordingly, server 130 may check if social information is up to date in cache layers 450 and fetch, from a social network, up to date information as needed. Any data, e.g., shares, likes and the like, may be kept up to date as described such that server 130 may be continuously aware of a context related to a user as reflected by a social network.

Cache layers 450 may use any logic, e.g., to achieve smart caching. In an embodiment, cache layers 450 is a processor and code adapted to cache data according to rules or thresholds. For example, cache layers 450 caches data related to news for a short period of time (e.g., minutes or hours) and caches data related to artists for days. For example, data related to news or sports channels in replaced in cache frequently while data for other channels is cached for longer periods of times. Such smart caching can optimize use of network and system resources and/or comply with API terms of service, e.g., so that a system will not poll resources too frequently.

Both personal or user specific data and global or public data may be cached. For example, cache layers 450 caches responses, programs or other content provided to a plurality of users and also, separately, caches data related to a specific user. For example, public cached data may be data related to news, sports or celebs. Private cached data may be personal images of a user (e.g., retrieved from the users account in a social network). In an embodiment, cache layers 450 may mix public cached data with user personal cached data and provide both to the user. In an embodiment, caching of public data may be smart caching as described and caching of personal data may be done based on other rules or criteria. For example, caching of personal data may be done for all data of the user such that a system always has some cached data to provide (e.g., even if no cached public data is available)

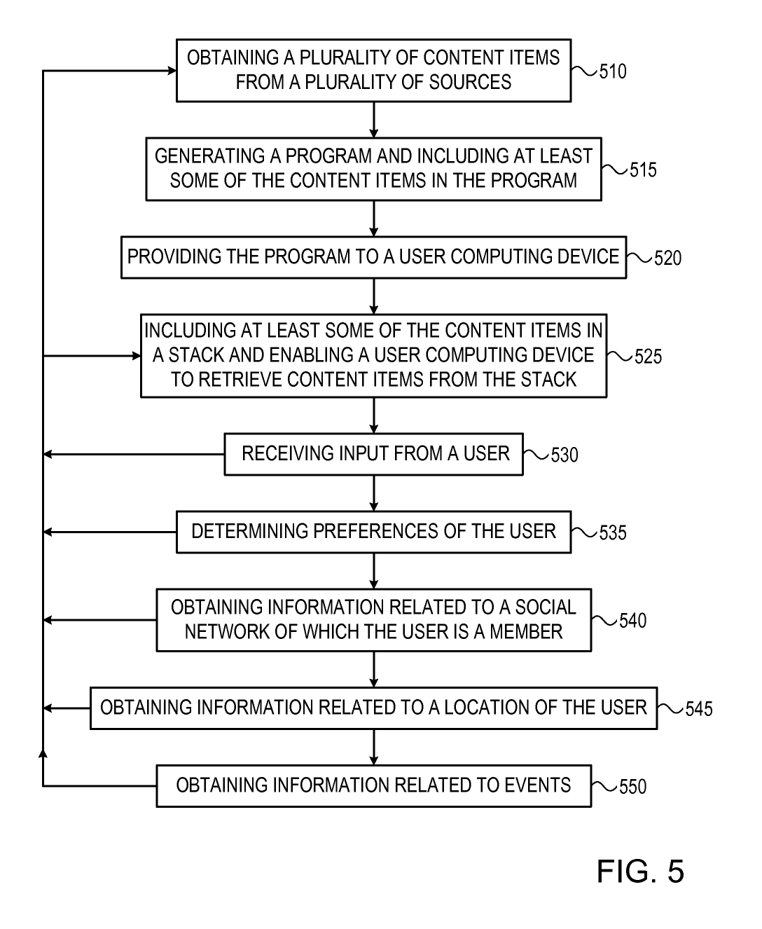

Reference is made to FIG. 5, a high level block diagram of a flow according to embodiments of the present invention. As shown by block 510, a method or flow may include obtaining a plurality of content items from a plurality of sources. For example, in an embodiment, server 130 obtains content items such as text, video clips or other multimedia content, images, “tweets” and “likes” from a social network, birthdays dates from a calendar of a user or from a social network and news related content from websites. In an embodiment, server 130 either downloads content from websites or other sources or server 130 may only obtain a link (e.g., a URL) to content and includes downloaded content or a link (or other reference) to content in a program as described herein.

As shown by block 515, a method or flow may include generating a program and including or adding to at least some of the content items in the program. For example, server 130 downloads an image from a website and includes the image in a program. A program generated may be a file that includes items in the program. In addition to the actual content, a program may include a list or other metadata. For example, a program may include a file that contains a list of the items in the program and, possibly, additional metadata. For example, a file included in a program may include the length of each item in the program or other details (e.g., artist name, source of image and the like). It will be understood that any method or construct may be used in order to include items in a program or associate items with a program such that the program may be provided by a first computing device (e.g., server 130) to a second computing device (e.g., client device 140).

As shown by block 520, a method or flow may include providing the program to a user's computing device. For example, server 130 provides programs to client device 140 as described herein. It will be understood that a set of programs may be provided, in sequence, such that a TV channel like effect is achieved whereby a sequence of programs are presented on client device 140, thus resembling a TV channel in the sense that a continuous and uninterrupted stream or flow of content is provided. Accordingly, a channel as referred to herein may be a sequence of programs provided to, and presented by, a user's computing device, e.g., client device 140 or mobile device 391.

As shown by block 525, a method or flow may include including or add at least some of the content items in a stack and enabling a user computing device to retrieve content items from the stack. For example, server 130 includes selected content items in one of stacks 315 and an element included in elements 330 pulls or downloads content items from the stack and presents the downloaded item.

A plurality of elements included in elements 330 may each extract items from a respective plurality of stacks and the elements may simultaneously or concurrently present content obtained from the stacks. For example, a first element included in elements 330 may extract, from a statuses stack, statuses of friends in a social network and continuously display the statuses on a display of client device 140 while a second element may extract, from an events stack, information related to events (e.g., events in the news, the music world and the like) and, at the same time, continuously display events on the display of client device 140.

Accordingly, using stacks as described, a system may continuously present to a user ongoing information, in real-time where the information may be related to a plurality of fields of interest or subjects. By interacting with client unit 142 (that in turn may control elements in a program as described) a user may activate or terminate elements in elements 330 thus activate or terminate presentation of content in stacks 315.

For example, by activating an element, a user may cause a sidebar or ticker to continuously present information related to any one of a plurality of subjects or fields, e.g., music, science, news, art and the like. Server 130 may generate a stack for any subject or field. The available stacks may be presented to a user. For example, in an embodiment, server 130 sends a list of active or available stacks to client unit 142 which in turn presents the list to a user. Client unit 142 may receive a selection of a stack from a user on client device 140, may activate an element (e.g., in global elements 340) and cause the element to present content retrieved from the selected stack. Accordingly, a user may be enabled to choose the stacks from which information is extracted and presented on the user's device. For example, while watching a video clip, a user may want to see statuses of friends on Facebook. In such case, the user may select the statuses stacks and statuses in the stack are presented as described herein.

As shown by block 530, a method or flow may include receiving input from a user. Any input may be received from a user and as shown by the arrows connecting block 530 and bocks 510 and 525, input from the user may be used in order to generate programs and/or generate stacks. For example, using a dedicated GUI object, a user may indicate whether or not he or she likes the program currently presented. In an embodiment, likes or dislikes (or “unlike” or “unlikes” as known in the art) are conveyed by client unit 142 to server 130 and server 130 uses likes or unlikes in order to generate programs for the user. For example, sources used for a program liked by a user are used, by server 130, again or more often. Similarly, server 130 may refrain from further use of sources if content obtained from these sources was indicated as “unliked” (or not indicated as liked) by the user. Accordingly, server 130 may generate a program or a stack of content items, for a user, based on input from the user. Some programs or stacks may be generated for a plurality of users. For example, based on likes of a plurality of users, server 130 generates and/or populates a program or stack.

As shown by block 535, a method or flow may include determining preferences of the user. For example, client unit 142 may present a questionnaire to a user and provide server 130 with input received. Based on answers of, or input from, the user, the user's preferences (e.g., taste in music, fields of interests and the like) may be know to server 130 and may be used by server 130 in order to select content for programs or stacks. In another embodiment, a user profile is maintained (e.g., in persistent database 460) and the user profile is used in generating programs and stacks for the user. For example, a user profile may be a file where interests, tastes or other preferences of the user are listed. Accordingly, server 130 may use a user profile to select content for a program or stack such that the content in a program or stack matches the user's preferences.

As shown by block 540, a method or flow may include obtaining information related to a social network of which the user is a member. For example and as described, posts or likes of friends of the user may be obtained an included in a program or stack. For example and as described, server 130 uses credentials received from a user (e.g., via client unit 142) to access an account of the user (e.g., a Facebook or Google+ account). Accordingly, server 130 may readily receive or obtain any information that may be obtained or seen by the user. For example, posts, likes, shares as known in the social network scene may all be available to server 130. Accordingly, server 130 may include in a stack or program posts, likes, shares or other information published, posted or shared by friends of a user. For example, extracting information from a posts stack, an element on client device 140 may continuously stream and present posts of friends of a user as they are posted, thus providing a continuous stream of textual data without any action being required from the user.

As shown by block 545, a method or flow may include obtaining information related to a location of the user. For example, using location services known in the art (e.g., services that use global positioning system (GPS)), a program or stack may be generated based on a location of a user. For example, client unit 142 may interact with a GPS system on a computing device of a user. In another embodiment, as known in the art, based on an Internet protocol (IP) address of client device 140 the location of client device 140 may be determined. In yet another embodiment a user may indicate his or her location (e.g., to client unit 142). A content included in program or a stack may be generated or selected based on a location of the user. For example, in generating a stack related to events, server 130 may search the Internet for events which are occurring no farther than ten miles from the user. Any other criteria may be used in order to select content based on a location.

As shown by block 550, a method or flow may include obtaining information related to events. For example, if server 130 learns of a new event (e.g., a party, a concert and the like) server 130 may generate a new stack or program and include content related to the event in the stack or program. Accordingly, programs or stacks may be automatically generated based on an event.

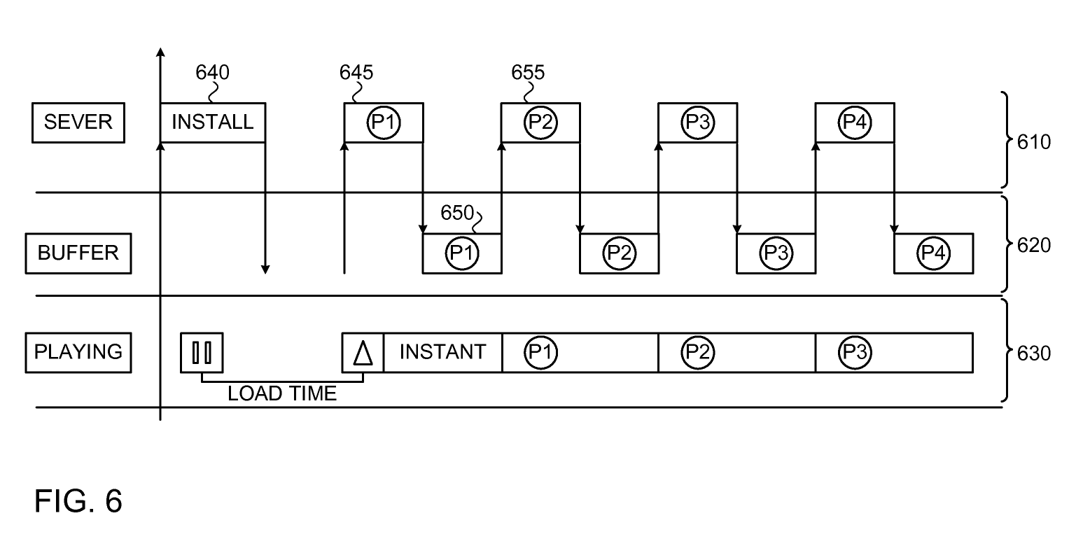

Reference is now made to FIG. 6 which shows high level time line according to embodiments of the invention. The time line diagram shown in FIG. 6 may be used by a system in order to provide content immediately upon request as well as to continuously provide an uninterrupted flow of content to a user. Three planes are shown in FIG. 6, server plane 610, buffer plane 620 and player plane 630, the time axis is a common axis for the three planes. As shown by 640, an instant clip is provided by server 130 immediately upon selection of a channel by a user. For example, server 130 stores an instant clip for each channel and, when a user selects the channel, server 130 is informed of the selection (by client unit 142) and immediately sends the instant clip associated with the channel. Accordingly, content is provided to a user immediately upon selection of a channel. As shown by 645, while the instant clip is played, server 130 generates the first program (labeled P1 for clarity). As shown by 650, buffering of the first program is also done while the instant clip is played. For example, server 130 begins sending the first program and portions received at a user device are buffered as described herein. as shown by 655, while the first program (P1) is presented, server 130 generates the second program for the channel (P2). As further shown, the second program is buffered and presented after the first program (P1) ends. Accordingly, a system delivers an uninterrupted flow of content or programs in a channel.

Reference is now made to FIG. 7 which shows high level block diagram of an exemplary computing device according to embodiments of the present invention. Computing device 700 may include a controller 705 that may be, for example, a central processing unit processor (CPU), a chip or any suitable computing or computational device, an operating system 715, a memory 720, a storage 730, an input devices 735 and an output devices 740.

Operating system 715 may be or may include any code segment designed and/or configured to perform tasks involving coordination, scheduling, arbitration, supervising, controlling or otherwise managing operation of computing device 700, for example, scheduling execution of programs. Operating system 715 may be a commercial operating system. Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 720 may be or may include a plurality of, possibly different memory units.

Executable code 725 may be any executable code, e.g., an application, a program, a process, task or script. Executable code 725 may be executed by controller 705 possibly under control of operating system 715. For example, executable code 725 may be an application or unit. For example, in an embodiment, client device 140 is similar to computing device 700 and includes at least a memory similar to memory 720 and a controller similar to controller 705. In an embodiment, client unit 142 is similar to executable code 725. In an embodiment, server 130 includes at least a memory similar to memory 720 and a controller similar to controller 705 and server unit 131 is a unit or module similar to executable code 725. For example, programs 150 are generated by server unit 131, sent to client device 140, stored in a memory such as memory 720 and are executed by a controller such as controller 705. In an embodiment, elements in a program are similar to, or implemented by, executable code 725.

Where applicable, executable code 725 may carry out operations described herein in real-time. Computing device 700 and executable code 725 may be configured to update, process and/or act upon information at the same rate the information, or a relevant event, are received. In some embodiments, more than one computing device 700 may be used. For example, a plurality of computing devices that include components similar to those included in computing device 700 (e.g., server 130 and client device 140) may be connected to a network (e.g., network 120) and used as a system. For example, generating programs, elements in a program and stacks as described herein may be performed in real-time by executable code 725 when executed on server 130 that may be similar to computing device 700 or may include components included in, or attached to, computing device 700.

Storage 730 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 730 and may be loaded from storage 730 into memory 720 where it may be processed by controller 705. For example, cache layers 450 and persistent database may be stored on a storage device or system similar to storage 730, may be loaded into a memory 720 in server 130 and may be processed or examined by a controller 705 in server 130.

In some embodiments, some of the components shown in FIG. 7 may be omitted. For example, memory 720 may be a non-volatile memory having the storage capacity of storage 730. Accordingly, although shown as a separate component, storage 730 may be embedded or included in memory 720.

Input devices 735 may be or may include a mouse, a keyboard, a touch screen or pad or any suitable input device. It will be recognized that any suitable number of input devices may be operatively connected to computing device 700 as shown by block 735. For example, input devices 735 may be any device operatively connected to user control 360 where user control 360 is a code segment similar to executable code 725.

Output devices 740 may include one or more displays, speakers and/or any other suitable output devices. It will be recognized that any suitable number of output devices may be operatively connected to computing device 700 as shown by block 740. Any applicable input/output (I/O) devices may be connected to computing device 700 as shown by blocks 735 and 740. For example, a wired or wireless network interface card (NIC), a modem, a printer, a universal serial bus (USB) device or external hard drive may be included in input devices 735 and/or output devices 740.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 720, computer-executable instructions such as executable code 725 and a controller such as controller 705.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method comprising:
obtaining a plurality of content items from a plurality of sources;
associating at least some of the content items with a program; and
providing the program to a user computing device.

2. The method of claim 1, comprising selecting content items to be included in a program based on at least one of: input from the user, a profile of the user and a preference of the user.

3. The method of claim 1, comprising generating a program based on at least one of: input from the user, a profile of the user and a preference of the user.

4. The method of claim 1, wherein at least one of the sources is a social network.

5. The method of claim 1, wherein the plurality of content items includes at least two content items of two content types respectively, the two content types selected from the group consisting of: text, multimedia and image.

6. The method of claim 1, comprising:
including a plurality of programs in a channel;
receiving, from a user, a selection of the channel; and
providing the channel to the user.

7. The method of claim 1, comprising:
presenting a list of a plurality of programs; and
based on a selection of the user, providing a selected program to the user.

8. The method of claim 3, comprising sequentially providing the plurality of programs to provide an uninterrupted and continuous content delivery channel.

9. The method of claim 1, comprising including at least some of the content items in a stack of content items and extracting, by the computing device, content items from the stack.

10. The method of claim 1, wherein at least some of the plurality of sources are selected by a user.

11. The method of claim 6, comprising enabling the user to share the channel.

12. The method of claim 1, comprising controlling a presentation of a program on a first computing device based on input received on a second computing device.

13. The method of claim 12, comprising causing the first computing device to present metadata related to a program based on input received on a second computing device.

14. The method of claim 12, comprising authenticating a user of the second device.

15. The method of claim 1, wherein the program includes text and video content obtained from a social network and wherein the text and video content is presented simultaneously on the user computing device.

16. The method of claim 1, comprising receiving, from the user, a selection of a content item included in a provided program and sharing the selected content item with members of a social network.

17. A system comprising:
a user computing device; and
a server, the server configured to:
obtain a plurality of content items from a plurality of sources,
generate a program and include at least some of the content items in the program, and
provide the program to the user computing device.

18. The system of claim 17, wherein the server is configured to select the content items to be included in a program based on at least one of: input from the user, a profile of the user and a preference of the user.

19. The system of claim 17, wherein at least one of the plurality of sources is a social network.

20. The system of claim 17, wherein the server is configured to:
include a plurality of programs in a channel;
receive, from the user, a selection of the channel; and
provide the channel to the user.
